(19) United States
(12) Patent Application Publication
(10) Pub. No.: US 2023/0185978 A1
(43) Pub. Date: Jun. 15, 2023

(54) INTERACTIVE GUI FOR PRESENTING CONSTRUCTION INFORMATION AT CONSTRUCTION PROJECTS

(71) Applicant: Buildots Ltd., Tel-Aviv (IL)

(72) Inventors: Roy DANON, Tel-Aviv (IL); Yakir SUDRY, Ramat-Gan (IL)

(73) Assignee: Buildots Ltd., Tel-Aviv (IL)

(21) Appl. No.: 18/080,820

(22) Filed: Dec. 14, 2022

Related U.S. Application Data
(60) Provisional application No. 63/289,164, filed on Dec. 14, 2021.

(51) Int. Cl. G06F 30/12

(52) U.S. Cl. CPC G06F 30/12; G06F 2111/18

(57) ABSTRACT

A method of generating an interactive graphical user interface (GUI), comprising: receiving one or more images captured by an image sensor of a mobile device in a construction site, each image is associated with one or more positioning parameter indicative of the mobile device’s position when the respective image is captured, rendering the image(s) on a display, receiving user input indicating selection of an area in the image(s) depicting a corresponding area in the construction site, accessing a 3D model documenting construction task status relating to each of a plurality of elements in the construction site, registering the image(s) to the 3D model according to the positioning parameter(s) to identify, in the selected area, elements documented in the 3D model, retrieving a respective construction task status relating to the identified elements; and adapting a GUI presented in association with the selected area according to the respective construction task status.

### RELATED APPLICATION(S)

This application claims the benefit of priority under 35 USC §119(e) of U.S. Provisional Pat. Application No. 63/289,164 filed on Dec. 14, 2021, the contents of which are all incorporated by reference as if fully set forth herein in their entirety.

### BACKGROUND

The present invention, in some embodiments thereof, relates to generating an interactive GUI presented in association with a construction site (project), and, more specifically, but not exclusively, to adapting an interactive GUI presented in association with a construction site according to construction task status retrieved from a three dimensional (3D) model of the construction site.

A 3D model of a construction site, for example, a Building Information Model (BIM) may comprise digital information descriptive of physical and/or functional features and characteristics of elements relating to the construction project (interchangeably designated construction site) which may be relevant to phases of, and often to a complete life cycle of the construction project.

The data in the 3D model may typically comprise time resolved data descriptive of 3D geometries of structural elements and components of the construction project, appliances housed in the construction project, and/or meta-information descriptive of the elements and appliances and how they function to cooperate in satisfying the constraints and purposes of the construction project.

The data in the 3D model may be used to monitor and manage phases in the lifecycle of the construction project and during a construction phase of the construction project. As such, this data may generally be accessed to disseminate timely data to persons involved with the construction project and to update and maintain the data current. Given the generally large and detailed amount of data associated with the many features of a construction project, accurately and easily accessing a BIM to update data in the BIM and/or extract data from the BIM may be a complex task.

### SUMMARY

According to a first aspect of the present invention there is provided a method of generating an interactive graphical user interface (GUI), comprising:
Receiving one or more images captured by an image sensor of a mobile device in a construction site. The one or more images are associated with one or more positioning parameter indicative of a position of the mobile device when the one or more images are captured.
Rendering the one or more images on a display.
Receiving user input indicating selection of an area in the one or more images depicting a corresponding area in the construction site.
Accessing a 3D model of the construction site documenting a construction task status of each of a plurality of elements in the construction site.
Registering the one or more images to the 3D model according to the one or more positioning parameters to identify, in the selected area, one or more elements documented in the 3D model.
Retrieving a respective construction task status relating to the one or more identified elements.
Adapting a GUI presented in association with the selected area according to the respective construction task status.

According to a second aspect of the present invention there is provided a system for generating an interactive graphical user interface (GUI), comprising one or more processors configured to execute a code. The code comprising:
Code instructions to receive one or more images captured by an image sensor of a mobile device in a construction site. The one or more images are associated with one or more positioning parameters indicative of a position of the mobile device when the one or more images is captured.
Code instructions to render the one or more images on a display.
Code instructions to receive user input indicating selection of an area in the one or more images depicting a corresponding area in the construction site.
Code instructions to access a 3D model of the construction site documenting a construction task status of each of a plurality of elements in the construction site.
Code instructions to register the one or more images to the 3D model according to the one or more positioning parameter to identify, in the selected area, one or more elements documented in the 3D model.
Code instructions to retrieve a respective construction task status relating to the one or more identified elements.
Code instructions to adapt a GUI presented in association with the selected area according to the respective construction task status.

In an optional implementation form of the first, and/or second aspects, the respective construction task status is updated in the 3D model according to user input received via the GUI.

In an optional implementation form of the first, and/or second aspects, a plurality of GUIs presented in association with the selected area depicted in a plurality of images captured by a plurality of image sensors of a plurality of mobile devices are adapted. Each of the plurality of GUIs is adapted according to the respective task status retrieved from the 3D model for the one or more identified elements.

In an optional implementation form of the first, and/or second aspects, a plurality of GUIs presented in association with a plurality of selected areas in the construction site depicted in a plurality of images captured by a plurality of image sensors of a plurality of mobile devices are adapted. Each of the plurality of GUIs is adapted according to a respective task status retrieved from the 3D model for one or more of the plurality of elements identified in a respective selected area.

In a further implementation form of the first, and/or second aspects, each of the plurality of elements is a member of a group consisting of: a structural element, an infrastructural element, a furniture, an appliance, and a decorative element.

In a further implementation form of the first, and/or second aspects, the construction task status of each element comprises one or more members of a group consisting of: construction status, construction timing, construction constraints, construction operational details, construction risks, constructor details, element details, and/or one or more image relating to the respective element.

In a further implementation form of the first, and/or second aspects, the construction task status relating to one or more of the plurality of elements is created according to one or more templates.

In a further implementation form of the first, and/or second aspects, the 3D model comprises a Building Information Model (BIM).

In an optional implementation form of the first, and/or second aspects, one or more Augmented Reality (AR) images are rendered on the display. The one or more AR images comprise one or more computer generated objects merged into one or more of the images.

In a further implementation form of the first, and/or second aspects, the one or more positioning parameters are derived from one or more extrinsic and/or intrinsic parameters of the image sensor.

In a further implementation form of the first, and/or second aspects, the one or more positioning parameters are computed by one or more devices deployed in the construction site which is configured to compute the one or more positioning parameters based on the position of the mobile device.

In a further implementation form of the first, and/or second aspects, the registering is based on a translation vector computed based on the one or more positioning parameters.

In a further implementation form of the first, and/or second aspects, the registering is based on matching one or more common features identified in one or more of the images and in the 3D model oriented with respect to each other according to the one or more positioning parameters.

In a further implementation form of the first, and/or second aspects, the one or more images comprise one or more frames extracted from a video stream captured by the image sensor.

In a further implementation form of the first, and/or second aspects, the display is a member of a group consisting of: a 2D display, and/or a 3D display.

In a further implementation form of the first, and/or second aspects, the image sensor is a member of a group consisting of: a camera, a video camera, a depth camera, an Infrared sensor, a thermal sensor, a panoramic image sensor, and/or a 360 imaging sensor array.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of adapting an interactive GUI for presenting construction task status at a construction site, according to some embodiments of the present invention;

FIG. 2 is a schematic illustration of an exemplary system for adapting an interactive GUI for presenting construction task status at a construction site, according to some embodiments of the present invention;

FIG. 3A and FIG. 3B are schematic illustrations of an exemplary construction site having a respective 3D model documenting construction task status of on-site elements, according to some embodiments of the present invention;

FIG. 4 is a schematic illustration of a mobile device used by a user to capture images at an exemplary construction site having a respective 3D model documenting construction task status of on-site elements, according to some embodiments of the present invention;

FIG. 5A, FIG. 5B, FIG. 5C, and FIG. 5D are schematic illustrations of images captured at an exemplary construction site which are presented on a display in association with a GUI to enable user interaction for retrieving and presenting construction task status relating to one or more elements depicted in the images, according to some embodiments of the present invention;

FIG. 6A and FIG. 6B are schematic illustrations of a GUI associated with presentation of images depicting an area in an exemplary construction site adapted to present construction task status relating to one or more elements in the area, according to some embodiments of the present invention; and

FIG. 7 is a flow chart of an exemplary process of adapting a GUI associated with presentation of images depicting an area in an exemplary construction site adapted to present construction task status relating to one or more elements in the area, according to some embodiments of the present invention.

### DETAILED DESCRIPTION

The present invention, in some embodiments thereof, relates to generating an interactive GUI presented in association with a construction project (site), and, more specifically, but not exclusively, to adapting an interactive GUI presented in association with a construction site according to construction task status retrieved from a 3D model of the construction site.

According to some embodiments of the present invention, there are provided methods, systems and computer program products for generating and/or adapting a GUI presented in association with a selected area in a construction site (interchangeably designated construction project herein after) according to construction tasks status retrieved from a 3D model of the construction site.

One or more users visiting the construction using mobile devices, for example, a Smartphone, a tablet, a laptop, and/or the like, or optionally 3D devices, such as, for example, stereoscopic googles, Helmet Mounter Display (HMD), an Augmented Reality (AR) device and/or the like associate with one or more image sensors may capture one or more images, either still images and/or video streams of the construction site and/or part thereof.

One or more of the captured images may be rendered, for example, on a display (e.g., screen, HMD, etc.) of one or more mobile device used by one or more of the users such that one or more of the users may select one or more areas of interest depicted in the image(s) which correspond to respective areas in the construction site.

In response to the selection, data may be retrieved from one or more 3D models associated with the construction site which may store data for the construction site and/or to one or more elements, objects and/or features relating to the construction site, for example, structural elements, infrastructural elements, furniture, appliances, decorative elements, and/or the like.

The 3D model may therefore comprise multi-disciplinary data to establish and produce a digital representation of the associated construction site across its lifecycle, from planning and design to construction, operations and maintenance. In particular, in addition to the 3D data, the 3D model may store and document construction task status relating to the construction site and/or to one or more of its related elements.

The construction task status may document status data of one or more constructions tasks conducted and/or planned at the construction site with respect to one or more of the elements at the construction site which may include elements already present in the construction site and/or elements planned and/or expected to be at the construction site in the future.

The construction task status data may comprise data items, information and details such as, for example, a phase of the construction task, a percentage of completion, construction task timing (e.g., start time, end time, milestones, etc.), constraints (e.g., deadline, dependency on other task(s), etc.), operational details (e.g., construction method, equipment, element details (e.g., material, composition, dimensions, packaging information, etc.), and/or the like.

Optionally, the construction task status created for one or more construction tasks may be created using one or more templates.

The image(s) captured at the construction site may be first registered to the 3D model in order to align their coordinate systems such that real world elements and features depicted in the image(s) may be correlated with corresponding elements and features in the 3D model.

Registration may be done according to on one or more positioning parameters recorded for the image sensor(s) used to capture the image(s), which are indicative of a pose (position) of the image sensor, in particular, at the time of capturing the image(s). One or more of the positioning parameters may be derived from one or more intrinsic and/or extrinsic parameters of the image sensor used to capture the image(s) which may be indicative of the pose of the image sensor at the time of capturing the image(s). In another example, the registration may be done using one or more Machine Learning (ML) models trained to identify visual feature at the construction site and register between the captured image(s) and the 3D model based on matching features identified in both the image(s) and in the 3D model and according to one or more of the positioning parameters.

After the image(s) and the 3D model are registered with each other, one or more elements may be identified in an area selected by one of a user and construction task status relating to the identified element(s) may be retrieved from the 3D model of the construction site.

A GUI presented in association with the selected area, for example, on the display of the client device of the user, may be then adapted and/or generated according to the construction task status fetched from the 3D model. For example, the GUI may be adapted to present one or more text items comprising text extracted from the construction task status retrieved from the 3D model. In another example, the GUI may be adapted to present one or more visual features, for example, a symbol, an icon, a shape, a texture, a color, and/or the like according to the construction task status retrieved from the 3D model.

Optionally, the construction task status relating to one or more of the identified elements may be updated in the 3D model according to user input received from the user. For example, one of the users, for example, a designer, a constructor, an inspector and/or the like may update one or more data items in the construction task status relating to one or more elements identified in the area selected by the user, for example, a start time, a deadline, a constraint, a risk and/or the like.

Moreover, the GUI may further enable the user to manipulate the rendered image(s) and/or part thereof to provide the user input comprising update construction task status.

Adapting the GUI presented in association with selected areas in a construction site according to construction tasks status retrieved from a 3D model of the construction site may present significant benefits and advantages compared to existing methods and systems for presenting construction project data.

First, presenting update construction task status to users in real-time at the construction site may significantly improve monitoring, controlling, and/or managing the construction tasks at the construction site. Moreover, updating the GUI according to the construction task status in relation to element(s) selected by the users may significantly improve the user experience of the users who may be able to easily and accurately retrieve, view, and/or track constriction tasks, specifically in relation to the elements involved in the construction tasks which are depicted in the image(s) in association with the GUI. In other words, updating the GUI according to the construction task status at locations, areas, and/or sections of the image(s) depicting the element(s) selected by the user may significantly improve the user experience of the user who may easily correlate between the construction task status and the element(s) of interest.

Moreover, updating the construction tasks status according to user input received from one or more users with respect to tone or more of the elements at the construction site may significantly increase traceability, control, and/or accuracy of the information documented by the construction tasks status.

Furthermore, using templates to create the construction tasks status for one or more of the construction tasks may significantly increase efficiency, consistency, accuracy and/or clarity of the data documented by the construction tasks status. Using templates may also significantly reduce effort, resources, and/or time required to create the construction tasks status.

In addition, registering the image(s) to the 3D model may enable accurate identification and determination of the element(s) located and/or planned to be located in the area selected by the user. As such, the construction status data presented to the users may be significantly more accurate and/or relevant as it may relate to the elements actually selected by the users.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

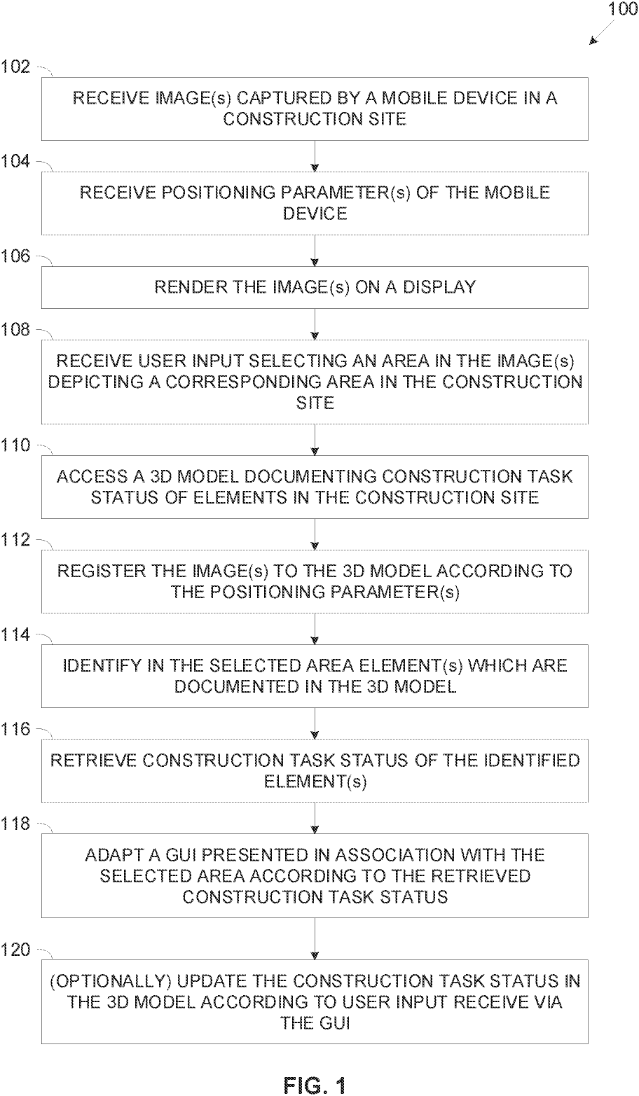

Referring now to the drawings, FIG. 1 is a flowchart of an exemplary process of adapting an interactive GUI for presenting construction task status at a construction site, according to some embodiments of the present invention.

A process 100 may be executed to adapt and/or generate a GUI presented in association with a selected area depicted in one or more images captured at a construction site (interchangeably designated construction project) to present construction task status relating to one or more elements in the selected area. The process 100 may be executed at one or more time points during the construction cycle from a planning phase to completion of work.

The image(s) captured by one or more image sensors of a mobile device used by a user at the construction site may be rendered and presented on a display of one or more mobile devices of the user to enable the user to select one or more areas depicted in the image(s). A GUI presented on the display(s) in association with the selected area may be adapted to preset construction task status information relating to one or more elements identified in the selected area which is retrieved from a 3D model of the construction site.

Optionally, via the GUI, the user may provide construction task status relating to one or more of the elements identified in the selected area to update the 3D model of accordingly.

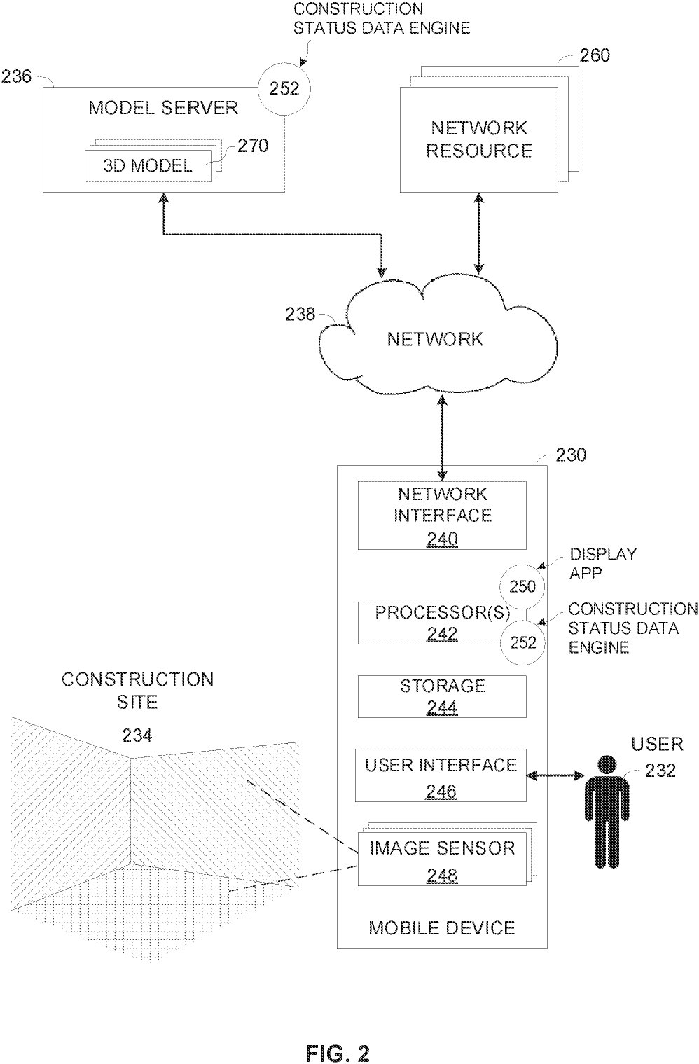

Reference is also made to FIG. 2, which is a schematic illustration of an exemplary system for adapting an interactive GUI for presenting construction task status at a construction site, according to some embodiments of the present invention.

An exemplary mobile device 230, for example, a Smartphone, a tablet, a laptop computer, and/or the like may be used by a user 232 to retrieve and view construction task status relating to one or more elements in a construction site 234 in which construction work (construction tasks) is planned and/or undergoing, for example, a building, a mall, an office, a store, a house, an apartment, a room, and/or the like.

The construction site 234 may be associated with one or more 3D models 270, for example, a BIM, and/or the like created to model the construction site 234 and one or more elements relating to the construction site 234, for example, a structural element, an infrastructural element, a furniture, an appliance, a decorative element, and/or the like.

In particular, the 3D model may store 3D data relating to the construction site 234 and/or to one or more of its related elements. The 3D model may comprise multi-disciplinary data to establish and produce a digital representation of the associated construction site 234 across its lifecycle, from planning and design to construction, operations and maintenance.

The construction site 234 may have multiple 3D models 270. For example, a first 3D model may document construction task status relating to one or more structural elements of the construction site 234, for example, a frame, a wall, a floor, a ceiling, a staircase, a door, a window, a roof, and/or the like. In another example, a second 3D model may document construction task status relating to one or more infrastructural elements at the construction site 234, for example, electricity, plumbing, communications, smart home, and/or the like. In another example, a third 3D model may document construction task status relating to one or more furniture elements at the construction site 234, for example, a closet, a cabinet, a table, a chair, a lamp, and/or the like. In another example, a fourth 3D model may document construction task status relating to one or more appliances at the construction site 234, for example, a kitchen appliance (e.g., refrigerator, oven, microwave, etc.,), an air-conditioning unit, a media appliance (e.g., television set, computer, router, access point, laptop, etc.), a security appliance (e.g., sensor, detector, alarm control unit, etc.), and/or the like. In another example, a fifth 3D model may document construction task status relating to one or more decorative elements at the construction site 234, for example, a curtain, a painting, a textured wall surface, and/or the like.

However, while the construction site 234 may have multiple 3D models 270, for brevity, a single 3D model 270 documenting construction task status relating to elements at the construction site 234 is described herein after.

The 3D model 270 may document a construction task status of each of a plurality of elements in the construction site 234. In particular, the construction task status may comprise information and details relating to the elements and/or one to or more construction tasks involving the elements. Each construction task may relate to one or more of the elements at the construction site 2345 and may comprise one or more construction tasks relating to one or more of the elements, for example, design, purchasing, transportation, construction, deployment, fitting, inspection, maintenance, repair, and/or the like. For example, a certain construction task may relate to one or more glass surfaces that need be placed at one or more window locations at the construction site 234. In such case, the construction task status of the certain construction task may comprise information relating to design of the glass surfaces, purchasing of the glass surfaces, delivery (transportation) of the glass surfaces to the construction site 234, fitting of the glass surfaces into frames at the designated windows, inspection of the fitted glass surfaces, cleaning of the glass surfaces, and/or the like.

The 3D model 270 created for the construction site 234 may be updated, continuously, periodically and/or per event according to progress of the construction tasks at the construction site 234. Therefore, while the 3D model 270 may document construction task status relating to one or more construction tasks which are in progress at the construction site, the 3D model 270 may further document construction task status relating to past events of one or more construction tasks which have already occurred. The 3D model 270 may further document construction task status relating to one or more future events of one or more construction tasks which may be based on estimation, plan and/or the like. Moreover, the 3D model 270 may document construction task status relating to one or more construction tasks which are not started yet.

As such, the 3D model 270 may be accessed at one or more time points during construction work at the construction site 234 to retrieve updated construction task status relating to one or more of the construction tasks involving one or more of the elements at the construction site 234.

The construction task status documented in the 3D model 270 for the elements at the construction site 234 may include various data items, information and details. For example, the construction task status of a respective element may include construction status of a construction task relating to the respective element, for example, a phase of the construction task (e.g., planning, under construction, in touchup, complete, repaired, redesigned, etc.), a percentage of completion, and/or the like. For example, continuing the exemplary certain construction task relating to the windows’ glass surfaces, the construction task status of the certain construction task may comprise a current phase of the certain construction task.

In another example, the construction task status of a respective element may include construction timing of a construction task involving the respective element, for example, a construction start time, a construction end time, a construction duration, timing of milestones defined for the construction task, and/or the like. For example, continuing the exemplary certain construction task relating to the windows’ glass surfaces, the construction task status of the certain construction task may describe, for example, a start time of the certain construction task, when is the nest milestone, an expected completion time of the certain construction task, and/or the like.

In another example, the construction task status of a respective element may comprise one or more construction constraints of a construction task involving the respective element, for example, a deadline, a dependency of the construction task on one or more other construction tasks, limited availability of the element, limited availability of one or more constructors responsible for the construction task and/or the like. For example, continuing the exemplary certain construction task relating to the windows’ glass surfaces, the construction task status of the certain construction task may describe, for example, a constraint indicating that the certain construction task can start only after window frames are installed at the window locations, a time of installation of the frames at the window locations, a time of delivery of the glass surfaces to the construction site 234, and/or the like.

In another example, the construction task status of a respective element may comprise one or more construction operational details of a construction task involving the respective element, for example, construction method, construction equipment, and/or the like. For example, continuing the exemplary certain construction task relating to the windows’ glass surfaces, the construction task status of the certain construction task may describe, for example, a fitting method of the glass surfaces in the window frames, a cleaning method for cleaning installed glass surfaces, and/or the like.

In another example, the construction task status of a respective element may comprise one or more construction risks identified for a construction task involving the respective element, for example, availability risk for equipment required to perform the construction task, a problem detected at the construction site which may prevent execution of the construction task and/or part thereof, and/or the like. For example, continuing the exemplary certain construction task relating to the windows’ glass surfaces, the construction task status of the certain construction task may describe, for example, a delay in delivery of the glass surfaces to the construction site 234, another construction operation which may affect the glass surfaces after installed in their frames (e.g., a polluting task which may damage and/or soil the glass surfaces, etc.) and/or the like.

In another example, the construction task status of a respective element may comprise one or more details of a constructor responsible for executing a construction task involving the respective element, for example, a name, contact information, skills, and/or the like. For example, continuing the exemplary certain construction task relating to the windows’ glass surfaces, the construction task status of the certain construction task may include, for example, details of the constructor assigned and responsible to install the glass surfaces in their frames, for example, company name, personal name, phone number, email address, and/or the like.

In another example, the construction task status of a respective element may comprise one or more details of the respective element, for example, material, composition, dimensions (e.g., height, length, width, weight, etc.), packaging information, quality certificate(s), liability record(s), production process, construction method, availability, supplier, and/or the like. The construction task status of one or more of the elements may further include one or more images, drawings, video clip, and/or other visual information relating to the respective element, for example, a picture of the respective element, a construction drawing describing deployment method of the respective element, a copy of a QA certificate, and/or the like. For example, continuing the exemplary certain construction task relating to the windows’ glass surfaces, the construction task status of the certain construction task may include, for example, dimensions of the glass surfaces, material, finishing, (e.g., tinting, polarization, etc.), and/or the like.

The construction task status created for one or more construction tasks relating to one or more of the elements at the construction site 234 may be created using one or more templates. For example, an element dimensions template may be used to create the construction task status of one or more construction tasks involving one or more elements, specifically to create the construction tasks status for the involved elements. In another example, a timeline graph template may be used to define the timeline of one or more construction tasks in their respective construction tasks status. In another example, a checklist template may be used to detail checklist actions of one or more construction tasks in their respective construction tasks status.

The mobile device 230 may include a network interface 240, a processor(s) 242, a storage 244, a user interface 246 and on or more image sensors 248.

The network interface 240 may include one or more wired and/or wireless interfaces for connecting to a network 238 comprising one or more wired and/or wireless networks, for example, a Local Area Network (LAN), a Wide Area Network (WAN), a Metropolitan Area Network (MAN), a Wireless LAN (WLAN), a cellular network, the internet, and/or the like to facilitate communication with more or more remote network resources 260 connected to the network 238, for example, a server, a storage server, a data center a database, a cloud service and/or platform and/or the like.

The processor(s) 242, homogenous or heterogeneous, may include one or more processors arranged for parallel processing, as clusters and/or as one or more multi core processors. The storage 244 may include one or more non-transitory persistent storage devices, for example, a Read Only Memory (ROM), a Flash array, a Solid State Drive (SSD), a hard drive (HDD) and/or the like. The storage 216 may also include one or more volatile devices, for example, a Random Access Memory (RAM), a cache memory and/or the like.

The user interface 246 may include one or more Human-Machine Interfaces (HMI) for interacting with the user 232. For example, the user interface 246 may comprise a display, for example, a screen, a projector, a touchscreen and/or the like for rendering images and presenting them to the user 232. The user interface 218 may further include one or more HMI interfaces for receiving user input, for example, a touch surface, a touchscreen, a touchpad, a keyboard, a pointing device, a digital pen, a microphone and/or the like.

The mobile device 230 may include one or more 2D devices comprising a user interface 246 supporting 2D display. However, alternatively and/or additionally, the mobile device 230 may include one or more 3D devices, for example, a stereoscopic goggles, a 3D Helmet Mount Display (HMD), and/or the like configured to project a 3D display to the user 232. The user interface 246 of such 3D mobile devices 230 may optionally include one or more 3D input HMIs configured to receive user input, for example, via hand gestures, body motion, and/or the like which may be captured by one or more 3D sensors coupled to the mobile device 230, for example, an image sensor, a motion sensor (e.g., accelerometer, a gyroscope, etc.), a proximity sensor, and/or the like.

The image sensor(s) 248, for example, a camera, a video camera, a depth camera, an Infrared sensor, a thermal sensor, and a panoramic image sensor, a 360 imaging sensor array and/or the like may be configured to capture visual data depicting the environment of the mobile device 230, for example, of the construction site 234.

The visual data may include, for example, one or more images, one or more image sequence, one or more video streams, one or more Infrared images, one or more thermal images and/or the like which may depend on the technology, operational capabilities and/or operational parameters of the image sensor(s) 248.

In case one or more of the image sensor(s) 248 is capable of capturing and producing images comprising depth data, a 3D presentation may be rendered on the display of the mobile device 230.

The image sensor(s) 248 associated with the mobile device 230 may be communicatively coupled to the mobile device 230, specifically to the processor(s) 242. For example, one or more of the image sensor(s) 248 may be integrated in the mobile device 230, for example, a Smartphone camera, a 3D image sensor of an HMD, and/or the like. In such case, the integrated image sensor(s) 248 may communicate with the processor(s) 242 via one or more communication channels internal to the mobile device 230. Optionally, one or more of the image sensor(s) 248 may be mechanically detached and separate from the mobile device 230, for example, a wearable image sensor, a helmet mounted camera, and/or the like. In such case, the integrated image sensor(s) 248 may communicate with the processor(s) 242 via one or more wired and/or wireless communication channels and/or networks supported by both the mobile device 230 and the image sensor(s) 248, for example, WLAN (e.g., Wi-Fi), Bluetooth (BT), and/or the like.

The processor(s) 242 may execute one or more software modules such as, for example, a process, a script, an application, an agent, a utility, a tool, an Operating System (OS) and/or the like each comprising a plurality of program instructions stored in a non-transitory medium (program store) such as the storage 244 and executed by one or more processors such as the processor(s) 242.

The processor(s) 242 may optionally integrate, utilize and/or facilitate one or more hardware elements (modules) integrated, utilized and/or otherwise available in the mobile device 230, for example, a circuit, a component, an Integrated Circuit (IC), an Application Specific Integrated Circuit (ASIC), a Field Programmable Gate Array (FPGA), a Digital Signals Processor (DSP), a Graphical Processing Unit (GPU) and/or the like.

The processor(s) 242 may therefore execute one or more functional modules implemented using one or more software modules, one or more of the hardware modules and/or combination thereof.

For example, the processor(s) 242 may execute a display application (app) 250 for presenting to the user 232 images captured at the construction site 234 and/or construction task status relating to one or more elements identified at the construction site 234, specifically elements identified in an area selected by the user 232. The display app 250 may further include a GUI for interacting with the user 232. For example, the GUI may be adapted according to the construction task status. In another example, the user 232 may interact with the GUI to provide user input.

The processor(s) 242 may further execute an construction status data engine 252 configured to execute the process 100 and/or part thereof. In particular, the construction status data engine 252 may receive user input indicative of a selected area in the construction site 234, identify one or more elements in the selected area, access the 3D model 270 of the construction site 234 to retrieve construction task status relating to the identified element(s) and adapt the GUI of the display app 250 according to the construction task status.

Optionally, the construction status data engine 252 and the display app 250 are integrated together in a single application.

According to some embodiments, the 3D model 270 of the construction site 234 may be locally stored at the mobile device 230, for example, in the storage 246. However, typically, to support efficiency, data sharing, scalability and/or the like, the 3D model 270 of the construction site 234 may be stored at one or more remote resources, for example, a model server 236 and/or a network resource 260 communicatively coupled to the mobile device 230 via the network 238, for example, a storage server, a data center, a cloud storage service, and/or the like.

Moreover, while the construction status data engine 252 may be executed by the mobile device 230, specifically by the processor(s) 242, in order to increase scalability, robustness, efficiency, performance, and/or the like, the construction status data engine 252 may be executed by a remote network resource communicatively coupled to the mobile device 230 via the network 238, for example, the model server 236 which may comprise one or more processor(s) such as the processor(s) 242, a storage such as the storage 244 and a network interface such as the network interface 240 for connecting to the network 238. In such case, the construction status data engine 252 executed by the remote model server 236 may communicate with the mobile device 230 to receive one or more images captured by the image sensor(s) 240 and/or user input provided by the user 232 and transmit instructions for adapting the GUI according to construction task status relating to element(s) identified in the construction site 234 which is retrieved from the 3D model 12 of the construction site 234.

Optionally, the model server 236, specifically, the construction status data engine 252 may be utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2), IBM Cloud, and/or the like.

For brevity the process 100 is described for presenting and optionally updating construction task status relating to a single construction site 234 to a single user 232 using a single mobile device 230. This, however, should not be construed as limiting since as may be apparent to a person skilled in the art, the process 100 may be easily expanded and scaled for a plurality of users such as the users 232 using a plurality of mobile devices such as the mobile device 230 at a plurality of construction sites such as the construction site 234.

As shown at 102, the process 100 may start with the construction status data engine 252 receiving one or more images captured at the construction site 234 by one or more of the image sensors 248 of the mobile device 230 of the user 232.

As described herein before, the images may comprise one or more still images captured by one or more image sensors 248, and/or one or more frames extracted from one or more video streams captured by one or more of the image sensors 248.

For brevity the process 100 is described herein after for a single image captured by a single image sensor 248. This however should not be construed should not be construed as limiting, since the same process 100 may be repeated for one or more additional images captured at different times and/or by different image sensors 248 of the mobile device 230.

As shown at 104, the construction status data engine 252 may further receive one or more positioning parameters associated with the image which are indicative of a position (pose) of the mobile device 230, in particular, a position of the image sensor 248 when the image is captured.

The image sensor 248 may be typically calibrated with respect to the mobile device 230, such that the position of the image sensor 248 may be derived from the position of the mobile device 230 and vice versa, the position of the mobile device 230 may be derived from the position of the image sensor 248.

The positioning parameters may indicate the position of the mobile device 230 with respect to one or more reference points at the construction site 234. The reference points may comprise, for example, one or more fixed structural points at the construction site 234, for example, an intersection line between two wall planes, a corner of two or more walls, a corner of a door frame, a corner of window frame, and/or the like. In another example, the reference points may comprise one or more reference marks (fiducial) placed and/or marked at predefined and known locations in the construction site 234, for example, a label, a sticker, a painted mark, an engraved mark, and/or the like.

The positioning parameters may include, for example, a vector, a distance and/or an angle of the mobile device 230 to one or more of the reference points, an angle of the image sensor 248 to one or more of the reference points, which may be expressed in one or more coordinate systems, for example, Cartesian coordinates. In another example, the positioning parameters may include a yaw, a pitch, and a roll of the mobile device 230 with respect to one or more of the reference points.

One or more of the positioning parameters may by derived from one or more extrinsic and/or intrinsic parameter of the image sensor 248. The intrinsic parameters of the image sensor 248 may comprise, for example, a focal length f, coordinates of a principal point (optical center), an aspect ratio of pixels in the photo-sensor of the image sensor 248, and/or the like. The extrinsic parameters of the image sensor may comprise components of a translation vector and a rotation matrix which express orientation of the image sensor 248 with respect to a coordinate system of the image sensor 248 which origin is at the principal point.

The construction status data engine 252 may receive one or more of the positioning parameters from the mobile device 230 which may have access to the positioning information and parameters of the image sensor 248.

Additionally, and/or alternatively, the construction status data engine 252 may receive one or more of the positioning parameters from one or more (monitoring) devices (e.g., system, apparatus, etc.) deployed in the construction site 234 which is configured to compute one or more of the positioning parameters based on the position of the mobile device 230 in the construction site 234.

For example, a certain monitoring device may collect images of the mobile device 230 at the construction site 234 which are captured by one or more monitoring image sensors deployed in the construction site 234 at known locations. In particular, the monitoring image sensors may capture the images of the mobile device 230 at the exact time when the image sensor 248 captures the image sent to the construction status data engine 252. Synchronization between the monitoring device and the mobile device 230 to determine the exact timing of image capturing is beyond the scope of this disclosure.

The monitoring device may then apply one or more methods, techniques and/or algorithms to compute one or more of the positioning parameters of the mobile device 230. For example, the monitoring device may collect multiple images captured by multiple different monitoring image sensors and apply one or more triangulation algorithms to compute one or more of the positioning parameters based on the position of the mobile device 230 in the multiple images and the known locations of the monitoring imaging sensors. In another example, the monitoring device may compute one or more of the positioning parameters based on the position of the mobile device 230 in the one or more images captured by one or more monitoring image sensors with respect to one or more of the reference points marked in the construction site 234.

As shown at 106, the received image may be rendered, for example, by the display app 250, on a display of the mobile device 230 for presentation to the user 232, for example, a screen, a touchscreen, a googles, an HMD, and/or the like according to configuration of the user interface 246.

Optionally, the display app 250 may render one or more Augmented Reality (AR) images on the display of the mobile device 230. The AR image(s) may comprise one or more computer generated objects which are merged into the image thus combining synthetic visual content with “real world” objects seen in the image.

As shown at 108, the construction status data engine 252 may receive user input indicating selection of a certain area in the image which depicts a corresponding area in the construction site 234.

The area selected by the user 232 may comprise practically any size of area which is depicted in the image ranging from a point (spot) pinpointing a specific location in the image to a large area which may encompass a large portion of the image and potential the entire image.

The user 232 may select the area and provide the user input accordingly by operating and/or using one or more of the HMI input interfaces available through the user interface 246, for example, a touchscreen, a pointing device, a 3D sensor, and/or the like.

Specifically, the user input may be received by a software module, for example, an application, a device driver, a OS, and/or the like which is locally executed by the mobile device 230, specifically by the processor(s) 242. In case, the construction status data engine 252 is executed locally at the mobile device 230, the construction status data engine 252 may communicate with the locally executed software module. However, in case the construction status data engine 252 is executed remotely, for example, by the model server 236, the construction status data engine 252 may communicate with the mobile device 230 to receive the user input and/or the selected area indicated by the user input.

As shown at 110, the construction status data engine 252 may access the 3D model 270 of the construction site 234, for example, a BIM, and/or the like which documents construction task status of each of a plurality of elements in the construction site 234.

As shown at 112, the construction status data engine 252 may register the received image depicting the construction site 234 and/or part thereof to the 3D model 270 of the construction site 234. Registering the received image to the 3D model 270 may be essential in order to accurately correlate “real-world” features, for example, elements, objects, and/or the like which are depicted in the image with corresponding features constructed and documented in the 3D model 270.

In particular, the construction status data engine 252 may register the received image to the 3D model 270 according to one or more of the positioning parameters associated with the image.

For example, the construction status data engine 252 may register the received image to the 3D model 270 according to a translation matrix and/or a translation vector (collectively designated translation vector herein after, computed based on one or more of the positioning parameters of the image.

A common coordinate system, for example, Cartesian coordinate system may be used for mapping both the “real world” as depicted in the image captured in the construction site 234 and the 3D model 270 of the construction site 234. However, while both coordinate systems are the same, tier point of origin and/or their orientation with respect to each other may be different. As known in the art, the translation vector which may further include a rotation matrix may be used to align between the coordinate system of the 3D model 270 and the real world coordinate system.

Since the positioning parameter(s) of the image which are indicative of the position of the mobile device 230, in particular, a position of the image sensor 248 when the image is capture, the translation vector may be computed based on these positioning parameter(s) to transform the coordinate system of the image to a predefined coordinate system which may be applied in the 3D model 270 having a predefined point of origin in the construction site 234 and a predefined orientation with respect to one or more of the reference point(s) defined at the construction site 234, for example, a feature, a marker, and/or the like.

In another example, the construction status data engine 252 may register the received image to the 3D model 270 based on matching of one or more common features identified in the received image and in the 3D model 270 oriented with respect to each other according to one or more of the positioning parameters. The common features which are distinguished and identifiable in the image and in the 3D model 270 may include, for example, one or more fixed structural points at the construction site 234, for example, an intersection line between two wall planes, a corner of two or more walls, a corner of a door frame, a corner of window frame, and/or the like. In another example, the common features may comprise one or more of the reference marks placed and/or marked at predefined and known locations in the construction site 234.

The construction status data engine 252 may use one or more methods, tools, and/or algorithms to identify one or more of the common features in the image. For example, the construction status data engine 252 may apply one or more computer vision, image processing, and/or the like to identify one or more of the features in the image. In another example, the construction status data engine 252 may apply one or more Machine Learning (ML) models, for example, a neural network, a classifier, a Support Vector Machine (SVM), and/or the like trained to identify one or more of the common features in visual data.

After common feature(s) are identified in both the image and in the 3D model 270, the construction status data engine 252 may register the image to the 3D model 270 according to one or more of the positioning parameters indicative of position and/or orientation of the image sensor 248 at the time the image was captured.

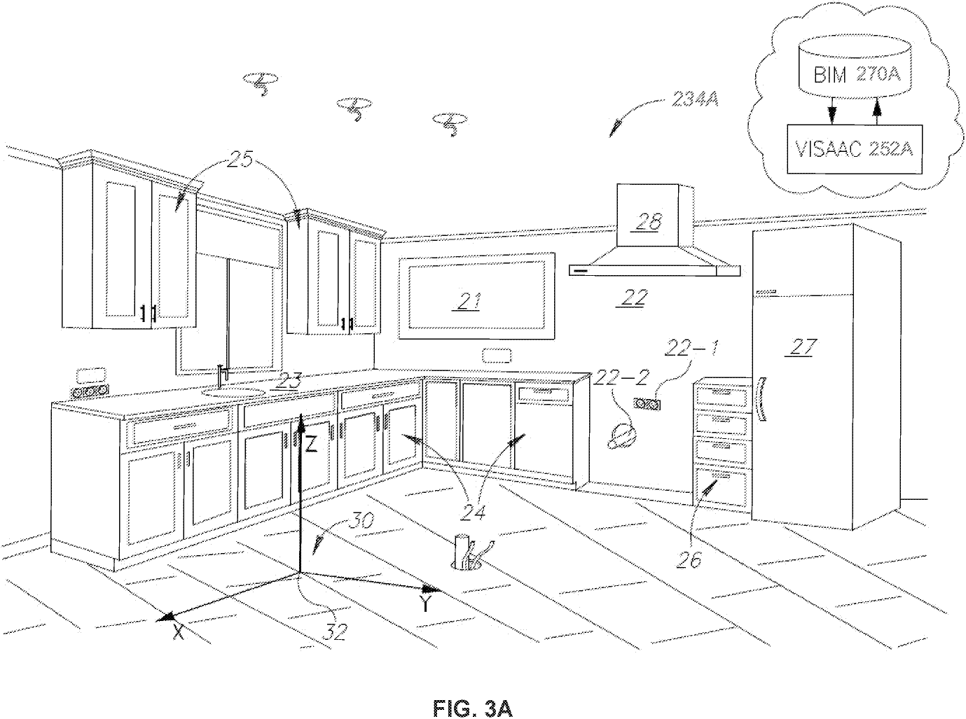

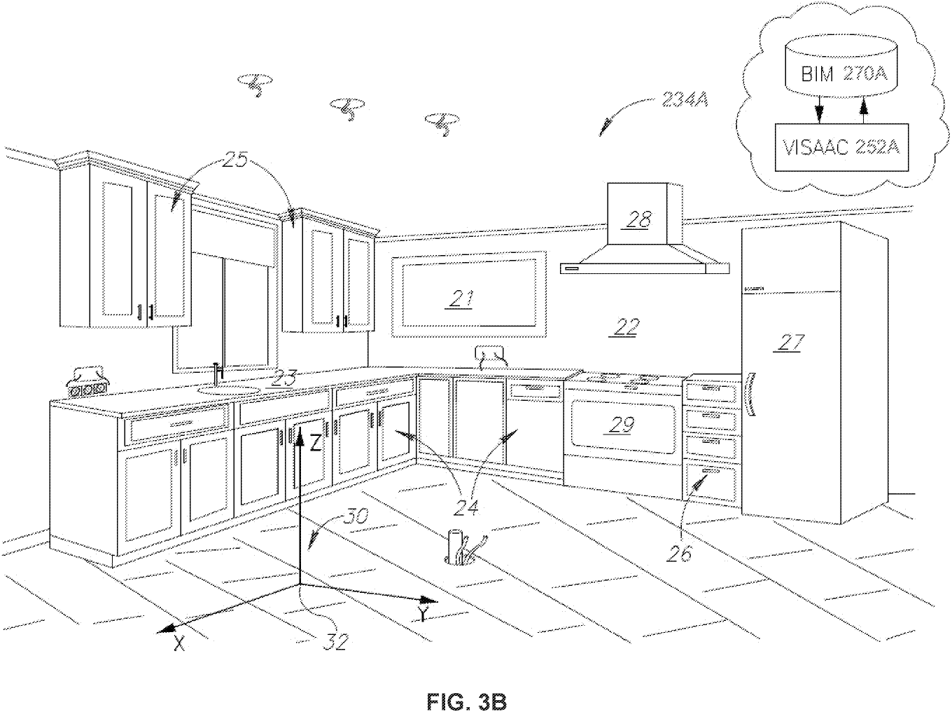

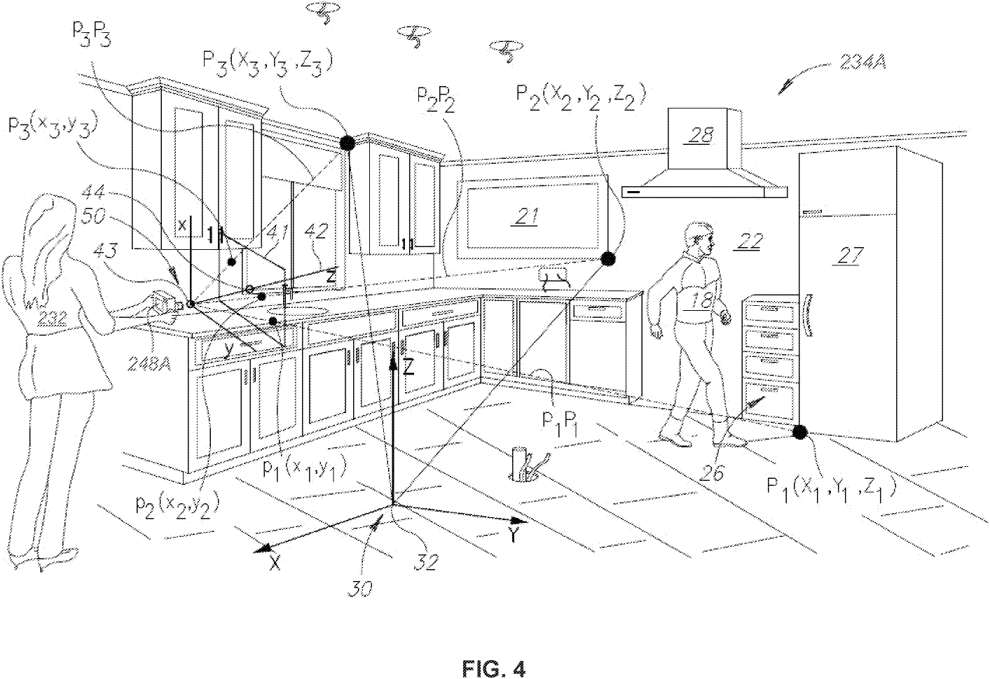

Reference is now made to FIG. 3A and FIG. 3B, which are schematic illustrations of an exemplary construction site having a respective 3D model documenting construction task status of on-site elements, according to some embodiments of the present invention. Reference is also made to FIG. 4, which is a schematic illustration of a mobile device used by a user to capture images at an exemplary construction site having a respective 3D model documenting construction task status of on-site elements, according to some embodiments of the present invention.

An exemplary construction site such as the construction site 234 may comprise a kitchen 243A at a given date (time) during its construction. The kitchen 234A may be part of a construction (building) project for which there is a 3D model such as the 3D model 270, for example, a BIM 270A which is optionally stored in a remote network resource such as the network resource 260, for example, a cloud based resource accessible to a construction status data engine 252 interchangeably designated VISAAC 252A herein after.

The BIM 270A may comprise spatial coordinates for features of the construction task defined relative to a “real world”, optionally Cartesian, “BIM” coordinate system 30 having a coordinate origin 32 and X, Y, and Z coordinate axes. At the given date, a plurality of elements are already installed in the kitchen 234A, for example, a window 21 is fitted to an external wall 22 of the kitchen 234A, counter tops 23, counter cabinets 24, wall cabinets 25, a utility drawer cabinet 26, a refrigerator 27, an evacuation hood 28, and various components of plumbing and electrical infrastructures are installed in the kitchen 234A. Among the infrastructure components are electrical outlets 22-1 and a gas pipe outlet 22-2.

In accordance with data in the construction BIM 270A, as of the given date the kitchen 234A, in addition to the elements which are already installed as shown in FIG. 3A, the kitchen 234A should, as schematically shown in FIG. 3B, have been included an oven 29 installed adjacent to the drawer cabinet 26 and under the evacuation hood 28.

By way of example, FIG. 4 schematically shows a user 232 of the VISAAC 252A using an image sensor such as the image sensor 248, for example, a camera 248A, to acquire an image of kitchen 234A at the given date for use in accessing the construction BIM 270A via the VISAAC 252A to follow progress of construction of the kitchen 234A. By happenstance, at a time at which the user 232 captures the image of the kitchen 234A, a worker 18 is walking towards refrigerator 27 and occluding electrical outlets 22-1 and gas pipe outlet 22-2 (shown in FIG. 3A).

The Camera 248A is represented by way of example as a pinhole camera and has components and features shown for convenience of presentation enlarged and in front of the camera. The camera 248A comprises an optical axis 42 that extends from an optical center 43 of the camera 248A to a camera image plane 41 on which the optical axis 42 is incident at a principal point 44. Camera image plane 41 is perpendicular to optical axis 42 and is located at a distance equal to a focal length, f, of the camera 248A from optical center 43. The camera 248A has a photo-surface (not shown) comprising camera pixels on which the camera images features of a scene. The photo-surface is typically parallel to camera image plane 41 and is located on a side of optical center 43 of the camera 248A opposite to that of the camera image plane 41 at a distance from the optical center 43 equal to the focal length f.

Locations of features of camera 44 and features of scenes that the camera images are defined by 3D coordinates referenced to a camera coordinate system 50 having an origin coincident with optical center 43 of the camera 248A and a z axis coincident with optical axis 42 of the camera 248A. Locations of the images of the features on camera image plane 41 and pixels comprised in the photo-surface on which the images of the features are registered are defined by 2D coordinates referenced to x and y axes of camera coordinate system 50. As referenced to camera coordinate system 50, coordinates of points on the photo-sensor at which projection lines from features imaged by camera 248A are incident are the negative of coordinates of points at which the projection lines respectively pass through camera image plane 41. Hereinafter, location of images of features imaged by camera 248A are referenced to coordinates of intersections of their respective projection lines on camera image plane 41.

The intrinsic parameters of camera 248A comprise, inter alia, the camera focal length f, coordinates of principal point 44, and an aspect ratio of pixels in the camera photo-sensor. For a feature imaged by the camera 248A, the camera’s intrinsic parameters may determine a transform that converts 3D coordinates of the feature referenced to camera coordinate system 50 to 2D, x and y coordinates of an image of the feature on image plane 41 and to coordinates of a pixel on the camera photo-sensor on which the feature is imaged. The camera extrinsic parameters which may define the pose (position) of the camera 248A may comprise components of a translation vector and a rotation matrix that convert 3D spatial coordinates of features in the kitchen 234A referenced to the BIM coordinate system 30 to 3D coordinates referenced to the camera coordinate system 50.

According to some embodiments, the VISAAC 252A is optionally configured to process the extrinsic and/or intrinsic parameters of the camera 248A for a given pose from which the image of the kitchen 234A is captured to provide an inverse projection transform. The inverse projection transform may determine a projection line in BIM coordinates 30 for a feature of the kitchen 234A that the camera 248A images based on 2D coordinates in the camera coordinate system 50 of an image of the feature on the camera image plane 41.

By way of example, large circles in FIG. 4 schematically represent points on surfaces of a selection of features in the kitchen 234A that the user 232 may image using the camera 248A. The large circles are identified by labels P1(X1,Y1,Z1), P2(X2,Y2,Z2), and P3(X3,Y3,Z3), where the subscript of the letter P identifies a point of a particular feature of the kitchen 234A and the 3D coordinates in parentheses following the subscripted P represent respective spatial coordinates for the feature point referenced to the X, Y, and Z axes of the BIM coordinate system 30. Kitchen feature points P1(X1,Y1,Z1), P2(X2,Y2,Z2), and P3(X3,Y3,Z3) are imaged on camera image plane 41 by corresponding camera image plane feature points represented on the camera image plane 41 by small circles that are respectively labeled pl(xl,y1), p2(x2,y2), and p3(x3,y3). 2D coordinates in parentheses in the label of each image plane feature point are respective 2D coordinates of the image plane feature point on image plane 41 referenced to the x and y axes of camera coordinate system 50.

For convenience of presentation kitchen feature points P1(X1,Y1,Z1), P2(X2,Y2,Z2), and P3(X3,Y3,Z3) and their respective image plane feature points pl(xl,yl), p2(x2,y2), and p3(x3,y3) may be referred to by their respective labels absent their associated coordinates. Projection lines for image plane feature points p1, p2, and p3 which are labeled p1P1, p2P2, and p3P3 extend from the optical center 43 which is the origin of the camera coordinate system 50 through image plane feature points p1, p2, and p3 to kitchen feature points P1, P2, and P3 respectively.

Optionally, the VISAAC 252A may use an inverse projection transform, optionally as described below, to process coordinates of image feature points p1, p2, and p3, referenced to camera coordinate system 50 to determine directions and locations of projection lines p1P1, p2P2, and p3P3 relative to the BIM coordinate system 30.

By way of illustrative example, to determine projection line p1P1, the VISAAC 252A may use the inverse projection transform to compute and/or determine direction cosines for example, which define a direction of projection line plP1 in the camera coordinate system 50 from projections onto the x, y, and z axes of a line from the coordinate origin (optical center 43) to coordinates x1, y1 of p1 on the image plane 41. The inverse projection transform may use a rotation matrix based on the extrinsic parameters of the camera 248A to transform the direction cosines in the coordinate system 50 to direction cosines for example, which may define a direction of plP1 in the BIM coordinate system 30. The inverse projection transform may use a translation vector defined by the extrinsic parameters of the camera 248A to determine a location of plP1 in the BIM coordinate system space 30. The location and direction of plP1 completely define plP1 as a line in the BIM coordinate space 30 that passes through kitchen feature point P1.

It is noted that whereas the VISAAC 252A is described above in accordance with an embodiment as processing extrinsic and intrinsic parameters to provide the inverse projection transform, practice of an embodiment is not limited to the VISAAC 252A determining the inverse projection transform. According to one or more embodiments, one or more other suitably configured computing entities may be used to acquire or receive, and process extrinsic and/or intrinsic parameters of the camera 248A to provide the inverse projection transform.

For example, the camera 248A may be configured to have access to construction data stored in the BIM 270A and, based on this construction data and the image of the kitchen 234A acquired by the camera 248A, determine the inverse projection transform. The camera 248A may transmit the transform to the VISAAC 252A and/or otherwise provide the VISAAC 252A with access to the inverse projection transform for use in determining the projection lines in the BIM coordinates system 30.

For convenience of non-limiting presentation, unless otherwise indicated, it is assumed that the VISAAC 252A acquires and processes the extrinsic and/or intrinsic parameters of the camera 248A to provide the inverse projection transform.

Reference is made once again to FIG. 1.

As shown at 114, after the image is properly registered to the 3D model 270, the construction status data engine 252 may identify one or more elements in the area selected by the user 232, in particular, elements documented in the 3D model 270 of the construction site 234.

The construction status data engine 252 may apply one or more of the image processing analysis tools, and/or ML models to analyze the selected area in the image depicting the construction site 234 and/or part thereof to identify one or more elements which are seen in the image. For example, based on analysis of a selected area in the image depicting a certain construction site 234, for example, the kitchen 234A, the construction status data engine 252 may identify one or more of the counter tops 23.

Optionally, the construction status data engine 252 may identify one or more elements which are planned and/or supposed to be in the selected area but are not seen in the image. For example, the construction status data engine 252 may identify the selected area in the 3D model 270 based on one or more features which are seen in the image and determine, based on data retrieved from the 3D model 270 with respect to the selected area, for example, construction task status data, that one or more elements are planned to be placed in that area. For example, as exemplified in FIG. 3A and FIG. 3B, based on construction task status data retrieved from the 3D model 270 with respect to the area beneath the evacuation hood 28 of the exemplary kitchen construction site 234A, the construction status data engine 252 may identify the oven 19 which is not located yet in the kitchen 234A but is rather planned to and/or should be placed in that area.

As shown at 116, the construction status data engine 252 may retrieve from the 3D model 270 respective construction tasks status relating to one or more of the elements identified in the area selected by the user 232. In particular, the construction status data engine 252 may retrieve respective construction tasks status relating to one or more construction tasks involving one or more of the elements identified in the selected area.

For example, continuing the previous example, assuming that the construction status data engine 252 identified one or more of the counter tops 23 in the kitchen construction site 234A, the construction status data engine 252 may retrieve construction tasks status relating to one or more construction tasks involving one or more of the counter tops 23, for example, placing the counter top(s) 23 on the cabinets 24. The construction tasks status may comprise, for example, dimensions of one or more of counter tops 23, and/or material(s) of which they are produced. In another example, the construction tasks status may comprise timing information, for example, a time of installation of the counter top(s) 23, a time of finishing work , for impale polishing, sink fitting, and/or the like.

As shown at 118, the construction status data engine 252 may adapt and/or instruct adaptation of the GUI of the display app 250 according to the respective construction task status retrieved from the 3D model 270. In particular, the construction status data engine 252 may adapt and/or instruct adaptation of the GUI which is presented by the of the display app 250 in association with the selected area according to the respective construction task status.

As described herein before, the construction status data engine 252 may be executed remotely by the model server 236, locally by the mobile device 230 or even integrated with the display app 250. Regardless of its specific deployment, the construction status data engine 252 which is in communication with the display app 250 may interact with the display app 250 to adapt the GUI. Therefore, for brevity, the construction status data engine 252 is described herein after to adapt the GUI whether it is done directly or indirectly.

The GUI may include one or more visual features which are presented by the display app on the display of the mobile device 230, for example, text, symbols, visual features, and/or the like. the GUI may further include one or more visual features, elements, and/or objects presented in the display which enable the user to interact with the display app 250 and/or with the construction status data engine 252 and provide input.

The GUI may be therefore adapted in one or more forms according to the respective construction task status retrieved from the 3D model 270. For example, the construction status data engine 252 may adapt the GUI of the display app 250 to present the retrieved construction task status. For example, the construction status data engine 252 may adapt the GUI to present the construction task status and/or part thereof in text form, for example, a text box, a floating text, a text overlay and/or the like. In another example, the construction status data engine 252 may adapt the GUI to embed the construction task status and/or part thereof in one or more visual features, elements and/or the like seen in the image.

Moreover, the construction status data engine 252 may adapt the GUI to present the retrieved construction task status in relation to the element(s) to which the construction task status related. For example, the GUI may be adapted to present a text box comprising the construction task status and/or part thereof with an arrow pointing to an element in the image to which the construction task status relates. In another example, the construction status data engine 252 may adapt the GUI to present text extracted from the construction task status inside boundaries of an element in the image to which the construction task status relates.

As described herein before, the construction status data engine 252 may instruct the display app 250 to render one or more AR images on the display of the mobile device 230 which may comprise one or more computer generated objects which are merged into the image captured by the image sensor 248. For example, the construction status data engine 252 may instruct the display app 250 to render one or more AR images in which the GUI is adapted according to the respective construction task status.

For example, continuing the previous example, assuming the construction status data engine 252 retrieves respective construction task status relating to the counter tops 23 and displays text extracted from the retrieved construction task status on the display of the mobile device 230. In such case, the construction status data engine 252 may further instruct the display app 250 to render one or more AR images in which the counter tops 23 are overlaid with one or more textures, colors, and/or patterns to highlight them which may indicate the user 232 that the counter tops 23 are the elements for which the construction task status is displayed.

In another example, continuing the previous example, assuming the construction status data engine 252 retrieves respective construction task status relating to the counter tops 23. Further assuming the respective construction task status comprises a schedule chart (graph) detailing a timeline and milestones of a construction task for installing the counter tops 23. In such case, the construction status data engine 252 may instruct the display app 250 to render one or more AR images in which the GUI is adapted to merge the schedule chart into the image, for example, overlay the schedule chart over the counter tops 23 depicted in the image.

As shown at 120, optionally the construction status data engine 252 may update the 3D model 270 according to information provided by the user 232 via the GUI presented by the display app 250. In particular, the construction status data engine 252 may update the respective construction task status, which relates to one or more of the elements identified in the area selected by the user 232, in the 3D model 270 according to user input received from the user 232 via the GUI. As stated herein before, while the identified element(s) may be already located in the construction site 234 and thus potentially visible in the image, one or more of the elements identified in the selected area may be still not present at the construction site 234 but are rather planned and/or expected to be placed there in the future.

The user input according to which the construction status data engine 252 may update the 3D model 270 may be provided by one or more users 232 at the construction site 234, for example, a constructor, an inspector, an architect, a worker, a site owner, a site leaser, and/or the like.

The updated constructions tasks status may include updated constructions tasks status information as described herein before, for example, construction status, construction timing, element details, constructor details, and/or the like. For example, a certain user 232 may update a start time of a certain construction task. In another example, a certain user 232 may update one or more constraints for a certain construction task.

Optionally, as described herein before, the process 100 may be scaled to a plurality of images, a plurality of mobile devices 230, a plurality of users 232 and/or the like.

For example, the construction status data engine 252 may adapt a plurality of GUIs presented in association with the selected area in a plurality of the mobile devices such as the mobile device 230 used by a plurality of users such as the user 232. For example, a plurality of users 232 each using his associated mobile device 230 executing the display app 250 and its GUI may be presented with images depicting a common selected area. As such, the GUI of the display app 250 may be adapted in at least some of the plurality of mobile devices 230 according to respective construction task status retrieved from the 3D model 270 of the construction site 234 in relation to one or more of the common elements identified in the selected area commonly presented at all mobile devices 230.

In an exemplary scenario of this embodiment, a group of users 232 each using his respective mobile device 230 may visit the construction site 234 together. Assuming that one of the users 232 selects an area in an image rendered on the display of his mobile device 230 and following his selection one or more of the other users 232 select the same area for discussing one or more aspects relating to one or more elements identified in the selected area. In such case, the construction status data engine 252 may adapt the GUI presented by the display app 250 executed by the plurality of mobile devices 230 which is presented in association with the selected area according to the respective construction task status retrieved from the 3D model 270 for the identified element(s).

In another example, the construction status data engine 252 may adapt a plurality of GUIs presented in association with a plurality of different areas selected in the construction site 234 by a plurality of users 232 each using his associated mobile device 230 which executes the display app 250 which presents the GUI in association with a respective one of the plurality of selected areas. In such case, the construction status data engine 252 may adapt each of the plurality of GUIs according to respective construction task status retrieved from the 3D model 270 of the construction site 234 in relation to one or more elements identified in the respective area.

In an exemplary scenario of this embodiment, a group of users 232 each using his respective mobile device 230 may visit the construction site 234 but may each explore different areas of the construction site 234. In such case, each of the users 232 may select a different area in a respective image rendered on his associated mobile device 230. As such, the GUI presented by the display app 250 executed by each of the mobile devices 230 may be presented in association with a respective selected area. The construction status data engine 252 may therefore adapt each GUI according to respective construction task status retrieved from the 3D model 270 for element(s) identified in each respective selected area.

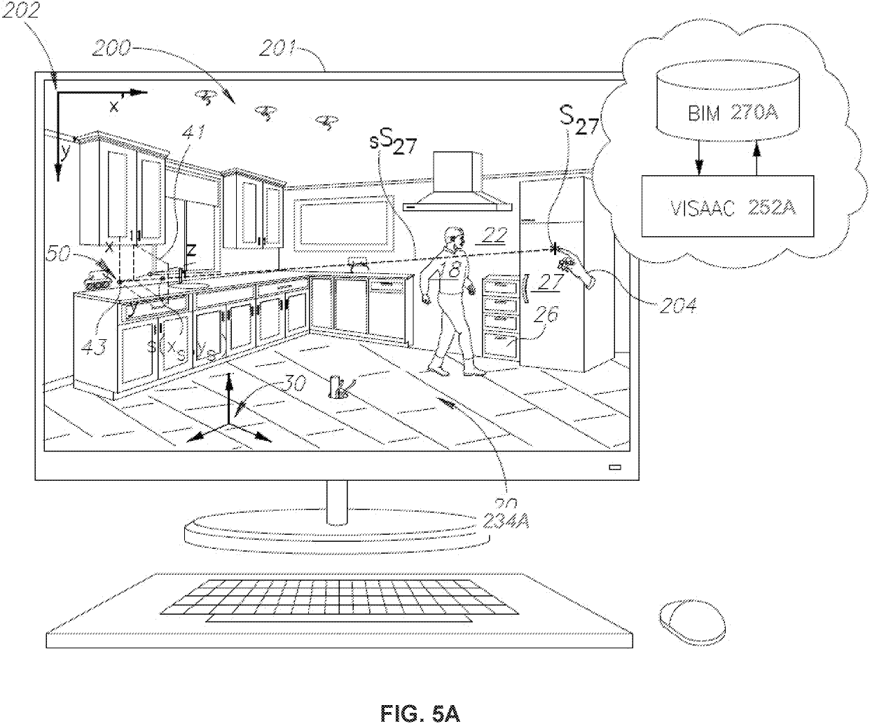

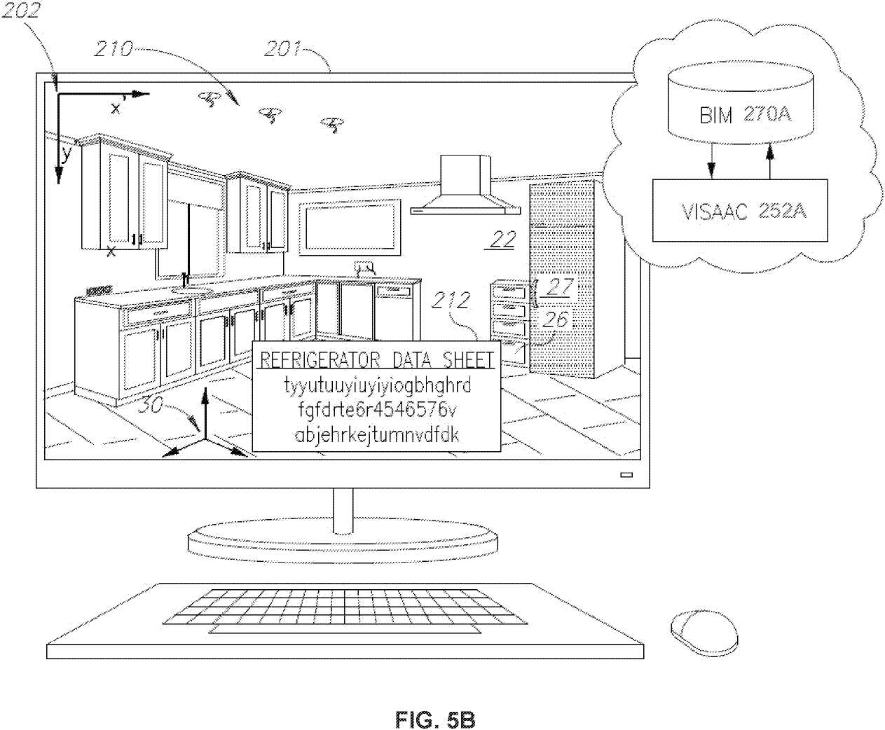

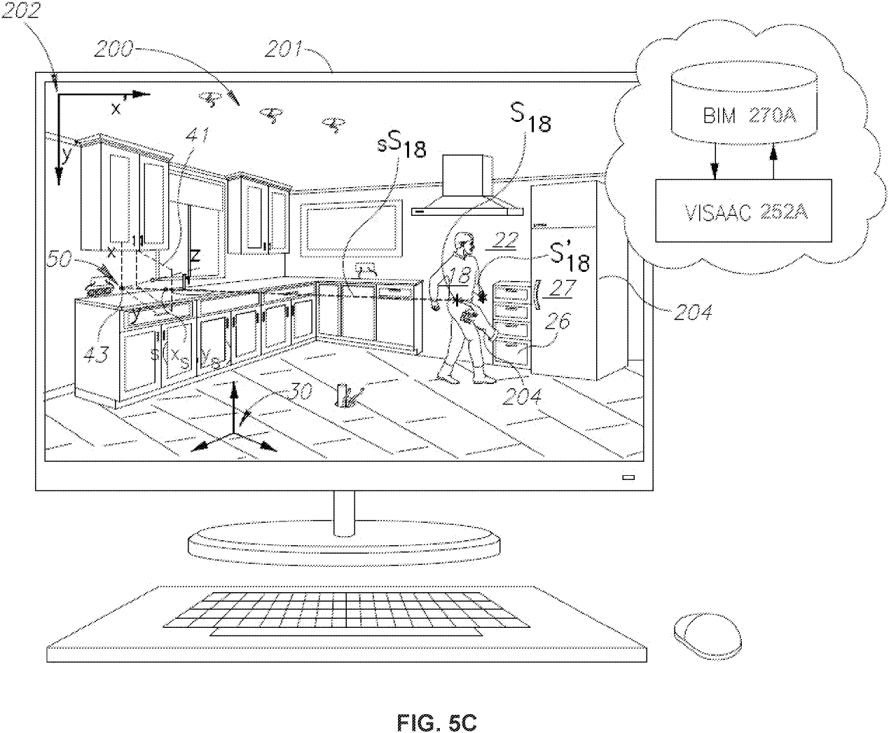

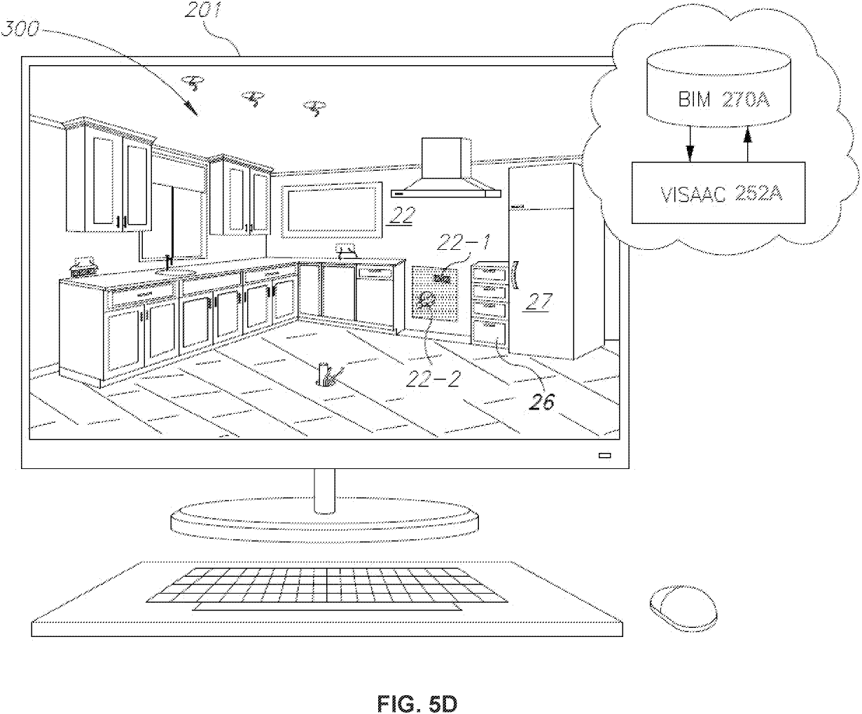

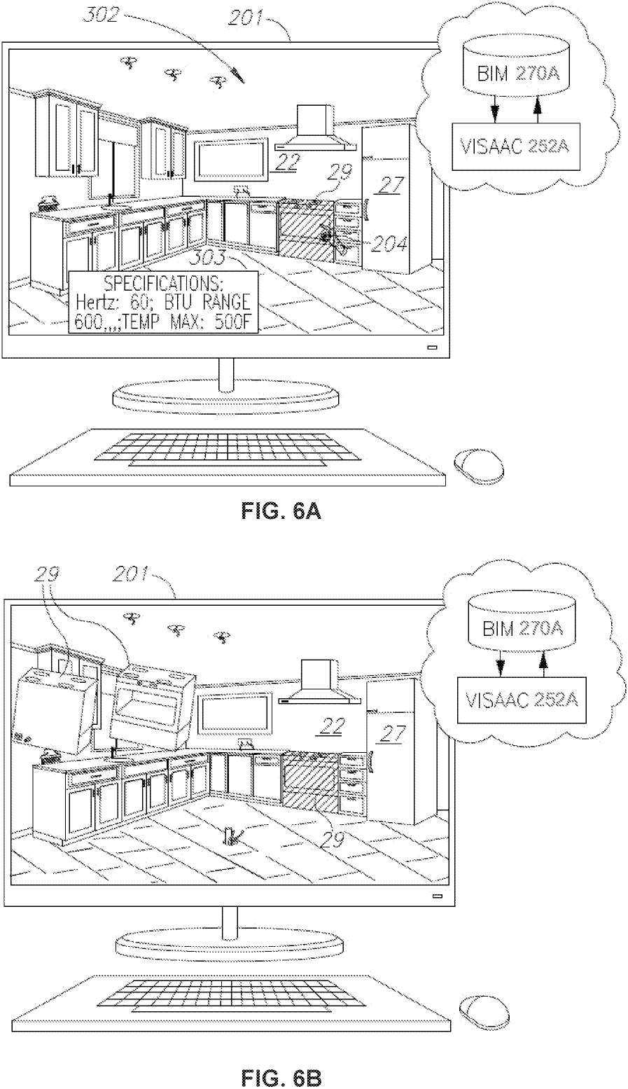

Reference is now made to FIG. 5A, FIG. 5B, FIG. 5C, and FIG. 5D, which are schematic illustrations of images captured at an exemplary construction site which are presented on a display in association with a GUI to enable user interaction for retrieving and presenting construction task status relating to one or more elements depicted in the images, according to some embodiments of the present invention. Reference is also made to FIG. 6A and FIG. 6B, which are schematic illustrations of a GUI associated with presentation of images depicting an area in an exemplary construction site adapted to present construction task status relating to one or more elements in the area, according to some embodiments of the present invention.

A VISAAC such as the VISAAC 252A may be configured, optionally as illustrated by exemplary scenarios discussed herein after with reference to FIGS. 5A-6B, to use projection lines defined by the inverse projection transform for features imaged by a camera such as the camera 248A to enable the a user such as the user 232 to interface with VISAAC 252A and a 3D model such as the BIM 270A and access data in the BIM 270A associated with the features.

In order to use the VISAAC 252A to query the BIM 270A with respect to one or more features and/or elements of a kitchen construction site such as the kitchen 234A at the given date, the user 232 may provide or otherwise make available the camera image to the VISAAC 252A. The VISAAC 252A optionally displays the camera image on a display used by the user 232 to interface with VISAAC 252A.

FIG. 5A schematically shows the VISAAC 252A instructing display of the camera image as a display image 200 on a screen 201 used by the user 232 to interface with the VISAAC 252A. 2D coordinates of display pixels of the screen 201 on which the VISAAC 252A displays the image 200 are optionally provided with reference to a 2D display coordinate system 202 having x′ and y′ coordinate axes and an origin in an upper left corner of screen 201. For convenience of presentation the camera image of the kitchen 234A provided to the VISAAC 252A and the display image that the VISAAC 252A displays may both be referenced by numeral 200, with the images distinguished by the adjectives “camera” and “display” respectively.

As described herein before, the VISAAC 252A, or as noted above any other suitable configured computing entity, may process the camera image 200 and/or sensor data generated by any of various position tracking devices comprised in the camera 248A and/or in the kitchen 234A to determine one or more of the extrinsic and/or intrinsic parameters of the camera to derive one or more positioning parameters indicative of a pose (position) from which the camera 248A acquired the uploaded camera image.

For example, the VISAAC 252A may process the uploaded camera image 200 of the kitchen 234A to register the uploaded image to one or more features of the kitchen 234A having known locations. Alternatively, and/or additionally, the VISAAC 252A may process data from one or more position sensors, for example, a GPS receiver, an Inertial Measurement Unit (IMU), and/or the like (not shown) coupled to the camera 248A to determine one or more of the extrinsic and/or intrinsic parameters of the camera 248A.

Intrinsic parameters of camera 248A, for example, the focal length, may be provided by the camera 248A and/or be stored in a memory of the VISAAC 252A. the VISAAC 252A may process the intrinsic and/or extrinsic data to determine an inverse projection transform for the pose of camera 248A at which the camera 248A acquired the image of the kitchen 234A as described herein before.

By way of example, the user 232 may be initially assumed to be interested in interacting with the display image 200 to query the BIM 270A and access details of a refrigerator 27 installed in the kitchen 234A. According to one or more embodiments, the user 232 may indicate his interest by selecting an area, i.e., a Region of Interest (ROI) in the display image 200 that is associated with the refrigerator 27, for example, located on the refrigerator 27.

As seen in FIG. 5A the selection may be schematically represented in the display image 200, for example, by a pointing hand icon 204. Moreover, a location of the selected ROI on the refrigerator 27 may be represented by an asterisk labeled “S27”.

Optionally, in order to accurately determine which element(s) the user 232 is interested in, the VISAAC 252A may determine display coordinates xS′ and yS′ for the location of S27 in the display image 200 referenced to axes x′ and y′ of the display screen coordinate system 202. The VISAAC 252A may process the display coordinates xS′ and yS′ to determine corresponding image coordinates (xs,ys) for a location on the image plane 41 of the camera 248A at which camera 248A imaged the ROI S27, as seen in FIG. 4. The VISAAC 252A may then process the image coordinates (xs,ys) using the inverse projection transform determined for the pose of the camera 248A to determine a projection line sS27 corresponding to coordinates (xs,ys) for the ROI S27.

According to one or more embodiments, the VISAAC 252A may estimate an intersection point of the projection line sS27 with a surface of an element (entity) documented and defined by data in the BIM 270A. The VISAAC 252A may then use the estimated intersection point to identify the entity in the kitchen 234A to which the user 232 pointed by selecting the ROI S27 (selected area).

For the scenario schematically illustrated in FIG. 4 and FIG. 5A, the identified entity (element) is the refrigerator 27. In response to identifying the refrigerator 27, as schematically shown in FIG. 5B, the VISAAC 252A may optionally render and display on the computer screen 201 a rendered display image 210 of the kitchen 234A which is based on the camera image 200 and data retrieved from the BIM 270A. For example, the VISAAC 252A may highlight the refrigerator 27 in the rendered image 210 to indicate to the user 232 what the VISAAC 252A identified. For example, the VISAAC 252A may highlight the refrigerator 27 as schematically indicated in FIG. 5B by stippling of the front surfaces of the refrigerator 27.

The VISAAC 252A may further display a data sheet 212 providing data relevant to the refrigerator 27 which is the element that the user may have requested in a query accompanying the selection of ROI S27.

It should be noted that, the rendered display image 212 of the kitchen 234A may not show the worker 18 because the worker 18 is not an entity (element) stored in the BIM 270A and whereas the VISAAC 252A, in accordance with an embodiment, may be configured to merge features from the display image 201 with the rendered image 212, in the current scenario it has not been requested to do so.

It should be further noted that the rendered display image 210 of the kitchen 234A may not exhibit the stove 29 (shown in FIG. 3B). Whereas, according to the BIM 270A, the stove 29 should have been installed in the kitchen 234A by the given date on which the user 232 used the camera 248A to image the kitchen 234A, the rendered image 212 does not show the oven 29, for example, because the VISAAC 252A had not been updated to reflect installation of the oven 29.

In an exemplary scenario, it is assumed that following receipt of the information regarding the refrigerator 27, the user 232 is interested in the status of infrastructure components on a selected area which comprises a region of the wall 22 that is occluded by the worker 18 in the display image 200. In interacting with the display image 200, as schematically shown in FIG. 5C, the user 232 may be unable to indicate a ROI on the region of the wall 22 in which he is interested because of the occlusion of the relevant section of wall 22 by the worker 18. According to one or more embodiments, the users 232 may select a region on the worker 18 that is in front of the region of wall 22 which is the ROI. As described in relation to FIG. 5A, in FIG. 5C the selection is also indicated by a hand icon such as the hand icon 204. However, since he is occluding the actual ROI, the selected region on the worker 18 is indicated by an asterisk labeled S18.

In response to selection of ROI S18, the VISAAC 252A may determine a projection line sS18 for the selection and may estimate an intersection point of the projection line sS 18 with a surface defined by data in the BIM 270A of an entity documented in the BIM 270A. However, the worker 18 is not an entity in the BIM 270A and, in accordance with an embodiment, the process of determining the intersection of projection line sSl8 with an entity in the BIM is transparent to the worker’s presence. As a result, the VISAAC 252A may determine that the projection line sS18 intersects an obscured section of the wall 22 behind the worker 18 at a point indicated by an asterisk labeled S′18.

In response to identifying the section of the wall 22 obscured by the worker 18, the VISAAC 252A may render and display, on the display screen 201, a rendered display image 300 schematically shown by way of example in FIG. 5D that displays wall region 22 and features of the wall region which are obscured by the worker 18. The displayed wall region may exhibit electrical outlets 22-1 and gas pipe outlet 22-2 obscured in the display image 200 as shown in FIG. 5A.

Optionally, as shown in FIG. 5D, the VISAAC 252A may highlight, as schematically indicated by stippling, the region identified by the VISAAC 252A as the region selected (pointed to) by the user 232. Optionally, the user 232 may select a feature, such as, for example, the electrical outlet 22-1, the gas outlet 22-2, and/or the like that are previously obscured by the worker 18 and shown in FIG. 5D similarly to the manner in which the user 232 selects the ROI as shown in FIG. 5A to access data with respect to the selected feature, namely the refrigerator 27.

As described herein before, the user 232 may acquire the camera image 200 of the kitchen 234A, schematically shown in FIG. 4 as the display image 200, on a given date and interacting with the VISAAC 252A for accessing information from BIM 270A based on the camera image 200. The camera image does not show the oven 29, which should have been installed by the given date, and shows the worker 18 partially obscuring the location where the oven 29 should have been installed.

According to some embodiments, the VISAAC 252A may comprise and/or have access to one or more trained neural networks executable to identify entities (elements) in the image received by the VISAAC 252A. Optionally the VISAAC 252A may use the neural network(s) to process the camera image 200, to independently determine that there is a person (worker 18) partly obscuring a region where the oven 29 should have been installed and that the oven 29 is missing.

Alternatively, and/or additionally, the VISAAC 252A may be configured to receive range data for one or more entities (elements) in the kitchen 234A and use the range data to independently determine distances of the entity(s) imaged in the camera image 200 and the presence of the worker 18 and absence of oven 29.

Optionally the camera 248A is a 3D range camera which provides a contrast image as well as a range image of the kitchen 234A and the VISAAC 252A receives the range data from the camera 248A. In response to determining the absence of the oven 29, the VISAAC 252A may alert the user 232 that construction of kitchen 234A is falling behind schedule.

Optionally, the VISAAC 252A may automatically update data, for example, the respective construction task status of a construction task relating to the oven 29, in the BIM 270A or in one or more other systems associated with the BIM 270A to indicate that construction of the kitchen 234A is falling behind schedule.

According to some embodiments, the VISAAC 252A may be queried for information regarding planned and/or actual construction tasks status of the kitchen 234A as a function of a date for a selected area (ROI) in the kitchen 234A selected as described above from a display image 200 of the kitchen 234A.

For example, when selecting the region of the wall 22 occluded by the worker 18 by selecting the region S18 in display image 200 as shown in FIG. 5C, the user 232 may have requested a planned status for construction of the kitchen 234A for the given date on which the camera 248A acquired the camera image 200. The VISAAC 252A may respond by rendering and displaying, as schematically shown in FIG. 6A, a rendered display image 302 of the kitchen 234A for the given date. Unlike the display image 200, the rendered display image 302 may show the kitchen 234A with the oven 29 installed.

The user 232 may then request information regarding the oven 29 from VISAAC 252A by selecting, as indicated by the hand icon 204, a region of the display image 302 that includes a portion of the oven 29. After identifying the oven 29 as an entity of interest selected by the user 232, the VISAAC 252 may optionally highlight the oven 29 as shown in the display image 302 to indicate to the user 232 that the VISAAC 252A identified the oven 29 as the object of interest indicated by the user 232. In response to a query to the VISAAC 252A requesting specifications for oven 29, the VISAAC 252A may extract specification data 303 from the BIM 270A and present the extracted specification data 303 in the display image 302.

According to some embodiments, the VISAAC 252A may be configured to enable the user 232 to manipulate one or more entities (elements) in the selected area for which the BIM 270A comprises sufficient data in a 3D virtual space to observe the respective entity from different directions.

For example, FIG. 6B schematically shows the oven 29 displayed in perspective from multiple different directions in response to the user 232 manipulating the oven 29.

It should be noted that while the description herein states that the user 232 may use the VISAAC 252A to access the BIM 270A to receive data that stored in the BIM 270A, this should not be construed as limiting. According to some embodiments of the present invention, the user 232 is not limited to using the VISAAC 252A to receive data which is already available in the BIM 270A but may optionally provide user input which may be used by the VISAAC 252A to update the BIM 270A. In such embodiments the VISAAC 252A may be configured to enable the user 232 to input data based on, and/or from, one or more images of the construction site 234 acquired using the camera 248A.

For example, assuming that the camera image of the kitchen 234 captured by the user 232 using the camera 248A and displayed on the computer screen 201 exhibits presence of the oven 29, as seen in FIG. 3B, at a time for which construction tasks status data in the BIM 270A indicates that the oven 29 is not yet installed, as seen in FIG. 3A. In such case, the User 232 may request the VISAAC 252A to search, optionally in the BIM 270A, for a time at which the oven 29 is planned to be installed in the kitchen 234A. Based on a response from the VISAAC 252A displaying a rendered display image 302 of the kitchen 234A in which the oven 29 is present, the user 232 may select the oven 29 in the rendered display image 302 and request the VISAAC 252A to retrieve one or more data records (construction tasks status) relating to the oven 29 from the BIM 270A and/or one or more other systems associated with the BIM 270A.

In response to receiving the data record(s), the user 232 may update the date of installation of the oven 29 in the data record(s) (construction tasks status). Moreover, the VISAAC 252A may be optionally configured to enable the user 232 to select the oven 29 shown in the rendered camera image 302 displayed on the computer screen 201 and instruct the VISAAC 252A to import one or more images of the oven 29 from the camera image 200 for updating the construction tasks status (construction data) of the oven 29 in the BIM 270A accordingly. The VISAAC 252A may determine the location of the “imported” oven 29 relative to other construction features in the kitchen 234A according to projection lines of one or more features of the oven 29 determined and/or computed by the VISAAC 252A using inverse projection transform.

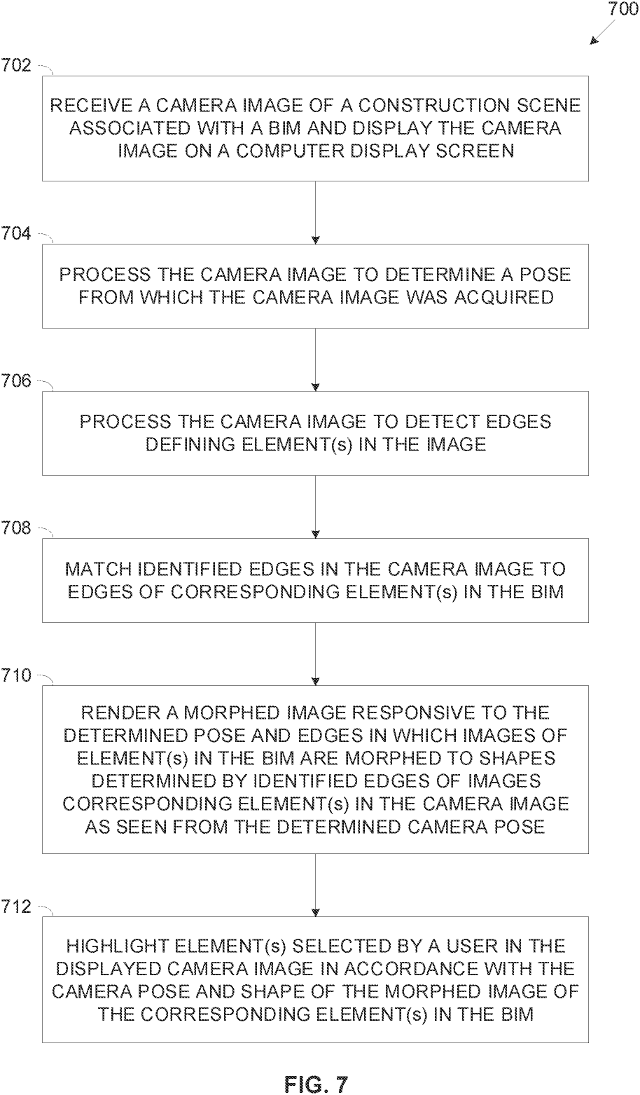

Reference is now made to FIG. 7, which is a flow chart of an exemplary process of adapting a GUI associated with presentation of images depicting an area in an exemplary construction site adapted to present construction task status relating to one or more elements in the area, according to some embodiments of the present invention.

An exemplary process 700 describes a VISAAC such as the VISAAC 252A configured to highlight one or more entities (elements) selected by a user such as the user 232 in a camera image such as the camera image 200 of a construction site such as the construction sites 234 to indicate to the user 232 which entity(s) the VISAAC 252A determines as selected by the user 232.

As shown at 702, the VISAAC 252 may receive the camera image 200 of a scene of the construction site 234 associated with a BIM such as the BIM 270A and displays the camera image 200 on a computer display such as the computer display 201.

As shown at 704, the VISAAC 252A may optionally processes the camera image 200 to determine a pose from which the camera image 200 was acquired.

As shown at 706, the camera image 200 may be optionally processed to identify edges of one or more elements (objects) in the camera image 200 which may define areas in the camera image 200 that are occupied by the elements.

As shown at 708, the edges identified in the camera image 200 may be optionally matched to edges of corresponding elements (objects) in the BIM 270A.

As shown at 710, the VISAAC 252A may render a morphed image responsive to the determined pose of the camera 248A and the identified edges in which images of one or more of the elements in the BIM 270A are morphed to shapes determined by the edges of the corresponding elements in the camera image 200 as seen from the camera pose.

As shown at 712, the VISAAC 252A may highlight an element selected by the user 232 in the displayed camera image 200 in accordance with the camera pose and the shape of the corresponding element in the BIM 270A in the rendered morphed image.

It should be noted that whereas in description of embodiments herein before, the VISAAC 252A is described as interfacing with the BIM 270A documenting 3D spatial construction data (construction task status) for one or more construction tasks relating to the construction site 234. This however, should not be construed as limiting since, according to some embodiments of the present invention, the VISAAC 252 is not limited to interfacing the BIM 270, and may be used with any of various models, also referred to as 3D construction models comprising 3D spatial construction data for one or more of the elements at the construction site 234. For example, the VISAAC 252A may be used to access and retrieve data from 3D engineering drawings of an aircraft using one or more camera images of one or more portions of the aircraft captured by a user such as the user 232 using a camera such as the camera 248A.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms 3D model and image sensor are intended to include all such new technologies a priori.

As used herein the term “about” refers to ± 10 %.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of generating an interactive graphical user interface (GUI), comprising:
receiving at least one image captured by an image sensor of a mobile device in a construction site, the at least one image is associated with at least one positioning parameter indicative of a position of the mobile device when the at least one image is captured;
rendering the at least one image on a display;
receiving user input indicating selection of an area in the at least one image depicting a corresponding area in the construction site;
accessing a 3D model documenting a respective construction task status relating to each of a plurality of elements in the construction site;
registering the at least one image to the 3D model according to the at least one positioning parameter to identify, in the selected area, at least one element documented in the 3D model;
retrieving a respective construction task status relating to the at least one identified element; and
adapting a GUI presented in association with the selected area according to the respective construction task status.

2. The method of claim 1, further comprising updating the respective construction task status in the 3D model according to user input received via the GUI.

3. The method of claim 1, further comprising adapting a plurality of GUIs presented in association with the selected area depicted in a plurality of images captured by a plurality of image sensors of a plurality of mobile devices, each of the plurality of GUIs is adapted according to the respective task status retrieved from the 3D model for the at least one identified element.

4. The method of claim 1, further comprising adapting a plurality of GUIs presented in association with a plurality of selected areas in the construction site depicted in a plurality of images captured by a plurality of image sensors of a plurality of mobile devices, each of the plurality of GUIs is adapted according to a respective task status retrieved from the 3D model for at least one of the plurality of elements identified in a respective selected area.

5. The method of claim 1, wherein each of the plurality of elements is a member of a group consisting of: a structural element, an infrastructural element, a furniture, an appliance, and a decorative element.

6. The method of claim 1, wherein the construction task status of each element comprises at least one member of a group consisting of: construction status, construction timing, construction constraints, construction operational details, construction risks, constructor details, element details, and at least one image relating to the respective element.

7. The method of claim 1, wherein the construction task status of at least one relating to at least one of the plurality of elements is created according to at least one template.

8. The method of claim 1, wherein the 3D model comprises a building information model (BIM).

9. The method of claim 1, further comprising rendering at least one augmented reality (AR) image on the display, the at least one AR image comprises at least one computer generated object merged into the at least one image.

10. The method of claim 1, wherein the at least one positioning parameter is derived from at least one extrinsic and/or intrinsic parameter of the image sensor.

11. The method of claim 1, wherein the at least one positioning parameter is computed by at least one device deployed in the construction site which is configured to compute the at least one positioning parameter based on the position of the mobile device.

12. The method of claim 1, wherein the registering is based on a translation vector computed based on the at least one positioning parameter.

13. The method of claim 1, wherein the registering is based on matching at least one common feature identified in the at least one image and in the 3D model oriented with respect to each other according to the at least one positioning parameter.

14. The method of claim 1, wherein the at least one image comprises at least one frame extracted from a video stream captured by the image sensor.

15. The method of claim 1, wherein the display is a member of a group consisting of: a 2D display, and a 3D display.

16. The method of claim 1, wherein the image sensor is a member of a group consisting of: a camera, a video camera, a depth camera, an Infrared sensor, a thermal sensor, a panoramic image sensor, and a 360 imaging sensor array.

17. A system for generating an interactive graphical user interface (GUI), comprising:
at least one processor configured to execute a code, the code comprising:
code instructions to receive at least one image captured by an image sensor of a mobile device in a construction site, the at least one image is associated with at least one positioning parameter indicative of a position of the mobile device when the at least one image is captured;
code instructions to render the at least one image on a display;
code instructions to receive user input indicating selection of an area in the at least one image depicting a corresponding area in the construction site;
code instructions to access a 3D model documenting a respective construction task status relating to each of a plurality of elements in the construction site;
code instructions to register the at least one image to the 3D model according to the at least one positioning parameter to identify, in the selected area, at least one element documented in the 3D model;
code instructions to retrieve a respective construction task status relating to the at least one identified element; and
code instructions to adapt a GUI presented in association with the selected area according to the respective construction task status.
